(19) United States
(12) Patent Application Publication
(10) Pub. No.: US 2025/0081080 A1
(43) Pub. Date: Mar. 6, 2025

(54) NETWORK DEVICES AND METHOD FOR FACILITATING GEOGRAPHICALLY LOCALIZED COMMUNICATION

(71) Applicants: Fani Bhushan, New Delhi (IN); Deepti Kumari, New Delhi (IN)

(72) Inventors: Fani Bhushan, New Delhi (IN); Deepti Kumari, New Delhi (IN)

(21) Appl. No.: 18/684,146

(22) PCT Filed: Aug. 16, 2022
(86) PCT No.: PCT/IB2022/057644

§ 371 Date: Feb. 15, 2024

(30) Foreign Application Priority Data
Aug. 16, 2021 (IN) 202111037017

(51) Int. Cl. H04W 40/20; H04L 67/50; H04L 67/52; H04W 76/12

(52) U.S. Cl. CPC H04W 40/20; H04L 67/52; H04L 67/535; H04W 76/12

(57) ABSTRACT

Network devices and method for facilitating geographically localized communication is disclosed. The network devices comprise a router for providing a local area network (LAN) and an access point for providing virtual access points. Further, the network devices comprise a processor configured to execute one or more predefined computer instructions to perform functions. The functions comprise providing the virtual access points that are detectable by user devices. The functions also comprise receiving a request for connection via a virtual access point from the user devices. Further, the functions comprise connecting the user devices to the LAN via the virtual access point. Furthermore, the functions comprise providing a custom application associated with one or more entities on the user devices connected to the LAN for the geographically localized communication with the entities and with respect to each other. The method comprises the steps performed by the network devices.

### FIELD OF INVENTION

The present disclosure relates in general to communication devices and more particularly, to network devices and a method for facilitating geographically localized communication.

### BACKGROUND OF THE INVENTION

In recent times, the Internet has enabled users to connect directly with different entities via an internet browser. Typically, each entity on the Internet is identified with one or more unique uniform resource locators (URLs) and the users connect to the entity by inputting the URL(s) in the browser. At present, the users are also able to connect to the entities via several desktop, web, and/or mobile applications. The Internet has also enabled the users associated with different internet service providers (ISPs) to communicate with each other via online chat and social media URLs and/or applications.

However, for instances when the users are in physical proximity to and/or in the vicinity of a physical store of the entity, the users may still be required to connect to entity with the URLs and/or the applications associated with the URL via their user devices. The users may be required to do so to perform one or more actions such as place an order, obtain an order code, a discount coupon, and/or check or compare online and offline prices of purchase items associated with the entity. This would result in significant use of internet data bandwidth and may also be time consuming depending on the internet speed on the user devices. Furthermore, in some locations with poor internet connectivity, the users may not be able to virtually access or connect with the entity and may therefore, be forced to rely on details provided in the physical store of the entity. In addition, in such locations, the users may have no alternative options to communicate with each other for instances when, for example, a user is displaced, lost, or needs to convey an emergency message. Similarly, in such locations, the entity may also not have an option to broadcast a message and/or an offering directly to the user devices. Even with internet connectivity, the entity may not be able to communicate directly with the users in the physical vicinity or proximity to the physical store and may resort to using user tracking and/or user location tracking technologies that require significant power and internet data bandwidth and/or usage to enable such communication with the users.

### SUMMARY OF THE INVENTION

In an aspect of the present disclosure, a network device associated with an entity is disclosed. The network device facilitates a geographically localized communication with the entity. The network device comprises a router for providing a local area network (LAN) and an access point coupled to the router for providing one or more virtual access points associated with the entity. The network device also comprises a storage unit comprising one or more custom applications. The custom applications are associated with the entity. Further, the network device comprises a memory to store one or more computer instructions and a processor configured to execute the one or more computer instructions in order perform one or more functions. The functions comprise providing the virtual access points via the access point. The virtual access points are detectable by one or more user devices. The functions also comprise receiving a request for connection via at least one virtual access point of the virtual access points from the user devices. Further, the functions comprise connecting the user devices to the LAN via the virtual access point. Furthermore, the functions comprise providing at least one custom application of the custom applications on the user devices connected to the LAN for the geographically localized communication with the entity.

In another aspect of the present disclosure, a network device associated with an entity is disclosed. The network device facilitates a geographically localized communication with one or more remote entities. The network device comprises a memory to store one or more computer instructions and a router for providing a local area network (LAN). The network device also comprises an access point coupled to the router for providing one or more virtual access points associated the remote entities. Further, the network device comprises a local domain name system (DNS) server coupled to the router for storing one or more service set identifiers (SSIDs) associated with one or more remote network devices. The remote network devices are associated with the remote entities respectively and are in communication with and within a communication range of the network device. The network device also comprises a storage unit for storing one or more custom applications associated with the remote entities respectively. The custom applications are associated with the SSIDs of the remote network devices. Further, the network device comprises a processor configured to execute the computer instructions in order perform one or more functions. The functions comprise providing the virtual access points associated with the remote entities via the access point. The virtual access points are detectable by one or more user devices and are associated with the SSIDs of the remote network devices. The functions also comprise receiving a request for connection via at least one virtual access point of the virtual access points from the user devices. Further, the functions comprise connecting the user devices to the LAN via the virtual access point. Furthermore, the functions comprise requesting the remote network devices associated with the at least one virtual access point to provide at least one custom application of the custom applications based on the SSIDs. The functions also comprise receiving the at least one custom application from the remote network devices via the router. In addition, the functions comprise providing the custom application on the user devices connected to the LAN for the geographically localized communication with the remote entities.

In yet another aspect of the present disclosure, a network device for facilitating a geographically localized communication with one or more entities is disclosed. The network device comprises a memory to store one or more predefined computer instructions and a router for providing a local area network (LAN). The network device also comprises an access point coupled to the router for providing one or more virtual access points. Further, the network device comprises a processor configured to execute the predefined computer instructions in order perform one or more functions. The functions comprise providing the virtual access points via the access point. The virtual access points are detectable by one or more user devices. The functions also comprise receiving a request for connection via at least one virtual access point of the virtual access points from the user devices. Further, the functions comprise connecting the user devices to the LAN via the virtual access point. In addition, the functions comprise providing a custom application on the user devices connected to the LAN. The custom application provides access to the entities and facilitates the geographically localized communication with the entities.

In yet another aspect of the present disclosure, a multi-network system for geographically localized inter-communication is disclosed. The multi-network system comprises a first network device and a second network device. The first network device provides a first local area network (LAN) and one or more first virtual access points associated with a first entity. Further, the first network device is configured to receive a first request for connection via at least one first virtual access point of the first virtual access points associated with the first entity from one or more first user devices. The first network device is also configured to connect the first user devices to the first local area network (LAN). Furthermore, the first network device is configured to provide a first custom application on the one or more first user devices connected to the first LAN. The second network device provides a second local area network (LAN) and one or more second virtual access points associated with a second entity. The second network device is in communication with and within a communication range of the first network device. Further, the second network device is configured to receive a second request for connection via at least one second virtual access point of the second virtual access points associated with the second entity from one or more second user devices. The second network device is also configured to connect the second user devices to the second local area network (LAN). In addition, the second network device is configured to provide a second custom application on the one or more second user devices to the second LAN. The first custom application and the second custom application are configured to facilitate the geographically localized inter-communication between the first user devices and the second user devices.

In yet another aspect of the present disclosure, a method for facilitating a geographically localized communication with one or more entities is disclosed. The method comprises a step of providing one or more network devices associated with the entities. The network devices are configured to communicate with each other and provide a LAN respectively. The method also comprises a step of providing one or more virtual access points via the network devices. The virtual access points are detectable by one or more user devices. Further, the method comprises a step of receiving a request for connection via at least one virtual access point of the virtual access points from the user devices. The virtual access point is associated with a network device of the network devices. Furthermore, the method comprises a step of connecting the user devices to the LAN provided by the network device via the virtual access point. In addition, the method comprises a step of providing at least one custom application on the user devices connected to the LAN for the geographically localized communication with the entities.

### BRIEF DESCRIPTION OF DRAWINGS

FIG. 1 is a schematic block diagram of a multi-network system 100 comprising network devices and user devices, in accordance with which various embodiments of the present disclosure may be implemented;

FIG. 2 is a schematic block diagram of different components in the first network device of FIG. 1, in accordance with an embodiment of the present disclosure;

FIG. 3 is a schematic block diagram of a processor in the first network device of FIG. 2, in accordance with the embodiment of the present disclosure;

FIG. 4 is an exemplary illustration of the first user device of FIG. 1 detecting virtual access points provided by the first network device of FIGS. 1-3, in accordance with the embodiment of the present disclosure;

FIG. 5 is an exemplary illustration of custom applications associated with entities provided on the first user device of FIG. 4 by the first network device of FIGS. 1-3, in accordance with the embodiment of the present disclosure;

FIG. 6 is an exemplary illustration of the first custom application of FIG. 5 associated with a first entity provided on the first user device of FIG. 4 by the first network device of FIGS. 1-3, in accordance with the embodiment of the present disclosure;

FIG. 7 is an exemplary illustration of a user interface provided on the first network device of FIGS. 1-3, in accordance with the embodiment of the present disclosure; and

FIG. 8 is a schematic block diagram of a method for facilitating a geographically localized communication with one or more entities using the multi-network system 100 of FIG. 1, in accordance with the embodiment of the present disclosure.

### DETAILED DESCRIPTION

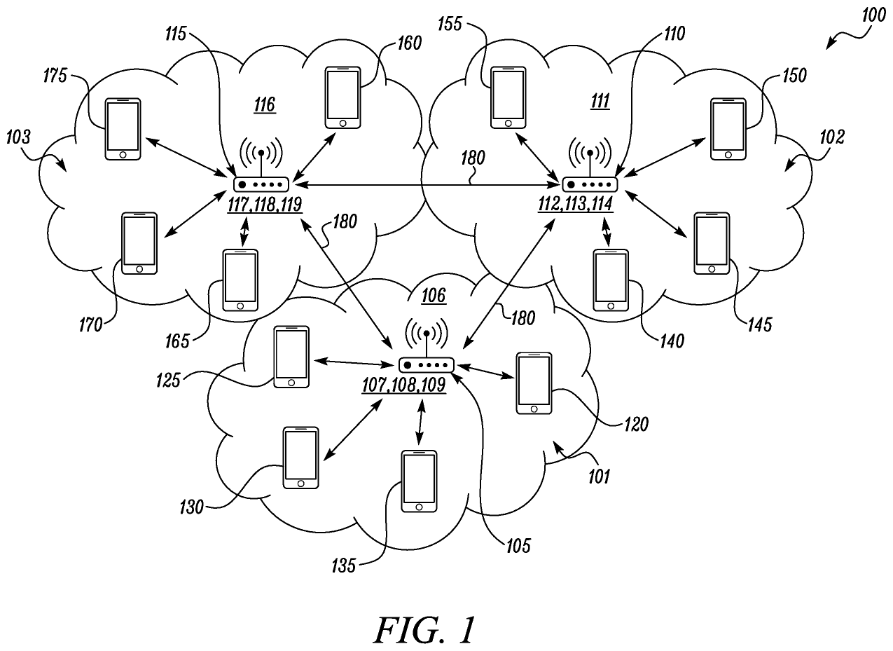

FIG. 1 is a schematic block diagram a multi-network system 100 comprising network devices 105, 110, 115 associated with entities 101, 102, 103, and user devices 120-135, 140-155, 160-175 located within a communication range of the network devices 105, 110, 115 respectively. The communication range may correspond to a pre-defined distance where communication can exist between the user devices 120-135, 140-155, 160-175 and the network devices 105, 110, 115 respectively. Examples of the network devices 105, 110, 115 and/or the user devices 120-175 include, but are not limited to, computers, laptops, mobile devices, handheld devices, personal digital assistants (PDAs), tablet personal computers, digital notebook, wearables, and similar electronic devices. In an embodiment, the network devices 105, 110, 115 may have Global System for Mobile communication (GSM) capabilities and may be configured to communicate with various cellular networks. In an embodiment, the network devices 105, 110, 115 may be similar with respect to each other and/or comprise similar hardware and/or software components respectively. In an embodiment, the network devices 105, 110, 115 may by physically positioned and/or stationed in, around, and/or in-between physical retail stores (not shown) associated with the entities 101, 102, 103 respectively. Examples of the entities 101, 102, 103 include, but are not limited to, product/service providers, product/service aggregators, and network device providers/aggregators. The network devices 105, 110, 115 may be configured to provide local area networks (LAN) 106, 111, and 116 respectively. The LANs 106, 111, and 116 correspond to communication networks such as, but not limited to, a wired LAN or a wireless LAN (WLAN). The network devices 105, 110, 115 may also be configured to provide one or more virtual access points 107-109, 112-114, and 117-119 respectively. In an embodiment, the virtual access points 107-109, 112-114, and 117-119 may correspond to a subset of the entities 101, 102, 103 respectively. For example, the virtual access points 107-109, 112-114, and 117-119 may correspond to the subset comprising, but not limited to, different sub-entities, store locations, and/or store sub-section names associated with the entities 101, 102, 103 respectively. In an embodiment, the network devices 105, 110, 115 may provide virtual access points 107-109, 112-114, and 117-119 on the user devices 120-135, 140-155, 160-175 respectively as visual indicators associated with the entities 101, 102. 103 respectively. Examples of the visual indicators include, but are not limited to, entity name, sub-entity names, brand names, store location and/or sub-section names, and symbols. The virtual access points 107-109, 112-114, and 117-119 provided by the network devices 105, 110, 115 respectively may be detectable by the user devices 120-135, 140-155, 160-175. In an embodiment, the user devices 120-135, 140-155, 160-175 may be configured to display the detected the virtual access points 107-109, 112-114, and 117-119 as the visual indicators respectively. The network devices 105, 110, 115 may be configured to receive a request for connection from and connect the user devices 120-135, 140-155, 160-175 to the LANs 106, 111, and 116 via the virtual access points 107-109, 112-114, and 117-119 provided as the visual indicators respectively. The network devices 105, 110, 115 may also be in communication with respect to each other via a network 180. The network 180 may be a wired Ethernet cable network or a wireless (Wi-Fi) network. The network devices 105, 110, 115 may also be within the communication range of each other. The communication range may correspond to a pre-defined distance where communication can exist between the network devices 105, 110, 115 via the network 180. The communication range may also correspond to a pre-defined distance where communication can exist between a network device, for example, the network device 105 and a user device, for example, the user device 130 via the LAN 106. The communication range of the network devices 105, 110, and 115 may be similar or different, and may be dependent on and/or vary based on hardware and software elements used in the network devices 105, 110, and 115 respectively. In an embodiment, the user devices 120-135, 140-155, 160-175 are not associated with the entities 101, 102, 103. The network devices 105, 110, 115 may identify each other based on the service set identifier (SSIDs) associated with the network devices 105, 110, 115 respectively. In an embodiment, the network devices 105, 110, 115 may store the SSIDs of each other and/or other network devices such as, but not limited to, hot-spot devices and Wi-Fi routers, available within the communication range of the network devices 105, 110, 115 respectively. The network devices 105, 110, 115 may also identify the user devices 120-135, 140-155, 160-175 connected to respective LANs 106, 111, and 116 based on the Media Access Control (MAC) address associated with the user devices 120-135, 140-155, 160-175 respectively. In an embodiment, the network devices 105, 110, 115 may store the MAC addresses of the user devices 120-135, 140-155, 160-175 respectively. In an embodiment, a network device, for example, 105, may store MAC addresses of the user devices, for example, 140-155 connected to the LAN 111 of another network device, for example, 110 and vice versa. The network devices 105, 110, 115 may provide one or more custom applications on the user devices 120-135, 140-155, 160-175 respectively. The custom applications provided may facilitate the geographically localized communication of the user devices 120-135, 140-155, 160-175 with each other and with the entities 101, 102, 103. In an embodiment, the custom applications provided on the user devices 120-135, 140-155, 160-175 may be associated with one or more sub-entities of the entities 101, 102, 103 respectively.

The entities 101, 102, 103 are herein referred to as first, second, and third entities respectively. The network devices 105, 110, 115 are herein referred to as first, second, and third network devices respectively. The user devices 120-135, 140-155, 160-175 are herein referred to as first, second, and third user devices respectively. The LANs 106, 111, 116 are herein referred to as first, second, and third LANs respectively. The virtual access points 107-109, 112-114, 117-119 are herein referred to as first, second, and third virtual access points respectively.

In an embodiment, the first network device 105 provides the first LAN 106, and the first virtual access points 107-109 associated the first entity 101. The first network device 105 may be configured to receive a first request for connection via the first virtual access point, for example, 107 associated with the first entity 101 from any one of or all the first user devices 120-135. The first user devices 120-135 may be within the communication range of the first network device 105. The first network device 105 may then connect the first user devices 120-135 requesting the connection to the first LAN 106 via the virtual access point 107. The first network device 105 may then provide a first custom application on the first user devices 120-135 connected to the first LAN 106. The second network device 110 provides the second LAN 111 and the second virtual access points 112-114 associated with the second entity 102. The second network device 110 is in communication with and within the communication range of the first network device 105. The second network device 110 may also be configured to receive a second request for connection via the second virtual access point, for example, 112 associated with the second entity 102 from any one of or all the second user devices 140-155. The second network device 110 may then connect the second user devices 140-155 requesting the connection to the second LAN 111 provided by the second network device 110. The second network device 110 may also provide a second custom application on the second user devices 140-155 connected to the second LAN 111.

The first custom application may facilitate the geographically localized communication between the first user devices 120-135 connected to the first LAN 106 and the first entity 101. The first custom application may also facilitate the geographically localized communication of the first user devices 120-135 connected to the first LAN 106 with each other. Further, the first custom application may facilitate the geographically localized communication between the first user devices 120-135 connected to the first LAN 106 and the second entity 102 based on the SSIDs associated with the second entity 102 that is stored in the first network device 105. In addition, the first custom application may also facilitate the geographically localized communication between the first user devices 120-135 connected to the first LAN 106 and the second user devices 140-155 connected to the second LAN 111 based on the SSIDs and the MAC addresses of the first user devices 120-135 and/or the second user devices 140-155 stored in the first network device 105. In an embodiment, the first custom application may also be configured to display the second user devices 140-155 connected to second LAN 111 on the first user devices 120-135. The first custom application may also be configured to receive a selection of a second user device, for example, 140 from a first user device, for example, 120. Further, the first custom application may be configured to facilitate the geographically localized inter-communication between the first user device, for example, 120 connected to the first LAN 106 and the selected second user device, for example, 140 connected to the second LAN 111. In an embodiment, the first custom application is configured to receive at least one media input from the first user device, for example, 120 and provide the media input received from the first user device, for example, 120 to the first network device 105. The first network device 105 may be configured to provide the media input received from the first user device, for example, 120 to other first user devices, for example, 125-135 connected to the first LAN 106. Examples of the media input include, but are not limited to, text, audio, video, and/or animation inputs. The first network device 105 may also be configured to provide the media input received from the first user device, for example, 120 to the second network device 110. The second network device 110 may be configured to provide the media input received from the first network device 105 to the second user devices 140-155 connected to the second LAN 111 via the second custom application. The first network device 105 and the second network device 110 may communicate with each other via the network 180 using the stored SSIDs and the MAC addresses to facilitate the geographically localized communication between the first user devices 120-135, the second entity 102, and the second user devices 140-155.

Similarly, the second custom application may facilitate the geographically localized communication between the second user devices 140-155 connected to the second LAN 111 and the second entity 102. The second custom application may also facilitate the geographically localized communication of the second user devices 140-155 connected to the second LAN 111 with each other. Further, the second custom application may facilitate the geographically localized communication between the second user devices 140-155 connected to the second LAN 111 and the first entity 101 based on the SSIDs of the first network device 105 stored in the second network device 110. In addition, the second custom application may also facilitate the geographically localized communication between the second user devices 140-155 connected to the second LAN 111 and the first user devices 120-135 connected to the first LAN 106 based on the SSIDs and the MAC addresses of the first user devices 120-135 and/or the second user devices 140-155 stored in the second network device 110. In an embodiment, the second custom application may also be configured to display the first user devices 120-135 connected to first LAN 106 on the second user devices 140-155. The second custom application may also be configured to receive a selection of a first user device, for example, 120 from a second user device, for example, 140. Further, the second custom application may be configured to facilitate the geographically localized inter-communication between the second user device, for example, 140 connected to the second LAN 111 and the selected first user device, for example, 120 connected to the first LAN 106. In an embodiment, the second custom application may also be configured to receive at least one media input from the second user device, for example, 140 and provide the media input received from the second user device, for example, 140 to the second network device 110. The second network device 110 may be configured to provide the media input received from the second user device, for example, 140 to other second user devices, for example, 145-155 connected to the second LAN 111. The second network device 110 may also be configured to provide the media input received from the second user device, for example, 140 to the first network device 105. The first network device 105 may be configured to provide the media input received from the second network device 110 to the first user devices 120-135 connected to the first LAN 106 via the first custom application. The second network device 110 and the first network device 105 may communicate with each other via the network 180 using the stored SSIDs and the MAC addresses to facilitate the geographically localized communication between the second user devices 140-155, the first entity 101, and the first user devices 120-135.

In an embodiment, in similarity to the first network device 105 and the second network device 110, the third network device 115 may connect the third user devices 160-175 to the third LAN 116 via any one of the third virtual access points 117-119. The third network device 115 may also provide a third custom application on the third user devices 160-175 connected to the third LAN 116. The third custom application may facilitate the geographically localized communication between the third user devices 140-155 connected to the third LAN 116 and first entity 101, the second entity 102, and/or the third entity 103. The third custom application may also facilitate the geographically localized communication of the third user devices 160-175 connected to the third LAN 116 with each other. Further, the third custom application may also facilitate the geographically localized inter-communication between the third user devices 160-175 connected to the third LAN 116 and the first user devices 120-135 connected to the first LAN 106. Similarly, the third custom application may also facilitate the geographically localized inter-communication between the third user devices 160-175 connected to the third LAN 116 and the second user devices 140-155 connected to the second LAN 111. In an embodiment, the third custom application may also be configured to display the first user devices 120-135 connected to first LAN 106 and the second user devices 140-155 connected to second LAN 111 on the third user devices 160-175. The third custom application may also be configured to receive a selection of a first user device, for example, 120 from a third user device, for example, 160. Further, the third custom application may be configured to facilitate the geographically localized inter-communication between the third user device, for example, 160 connected to the third LAN 116 and the selected first user device, for example, 120 connected to the first LAN 106. In an embodiment, the third custom application is configured to receive at least one media input from the third user device, for example, 160 and provide the media input received from the third user device, for example, 160 to the third network device 115. The third network device 115 may be configured to provide the media unput received from the third user device, for example, 160, to other third user devices, for example, 165-175 connected to the third LAN 116. The third network device 115 may also be configured to provide the media input received from the third user device, for example, 160 to the first network device 105 and/or the second network device 110. The first network device 105 may be configured to provide the media input received from the third network device 115 to the first user devices 120-135 connected to the first LAN 106 via the first custom application. Similarly, the second network device 110 may also be configured to provide the media input received from the third network device 115 to the second user devices 140-155 connected to the second LAN 111 via the second custom application. The third network device 115, the first network device 105, and the second network device 110 may communicate with each other via the network 180 using the stored SSIDs and the MAC addresses to facilitate the geographically localized inter-communication between the third user devices 140-155, the first entity 101, the second entity 102, the first user devices 120-135 and the second user devices 140-155.

In an embodiment, the first custom application, the second custom application, and/or the third custom application may be similar and comprise a chat application or a social media application. Further, it may be appreciated that, similar to the third custom application, the first custom application may also be configured to facilitate inter-communication between the first user devices 120-135 connected to the first LAN 106, the third entity 103 and/or the third user devices 160-175 connected to the third LAN 116. Similarly, the second custom application may also be configured to facilitate inter-communication between the second user devices 140-155 connected to the second LAN 111, the third entity 103 and/or the third user devices 160-175 connected to the third LAN 116. In an embodiment, the network devices 105, 110, 115 may also be similar in functionality and may comprise similar hardware and/or software elements and/or capabilities. In another embodiment, the network devices 105, 110, 115 may be similar in functionality but may vary only in the hardware and/or software elements and/or capabilities with respect to each other. Accordingly, it may be appreciated that the functions performed by the first network device 105 may be equally applicable and/or similar to the functions performed by the second network device 110 and/or the third network device 115. For purposes of clarity, the functions performed by the first network device 105 will be described herein.

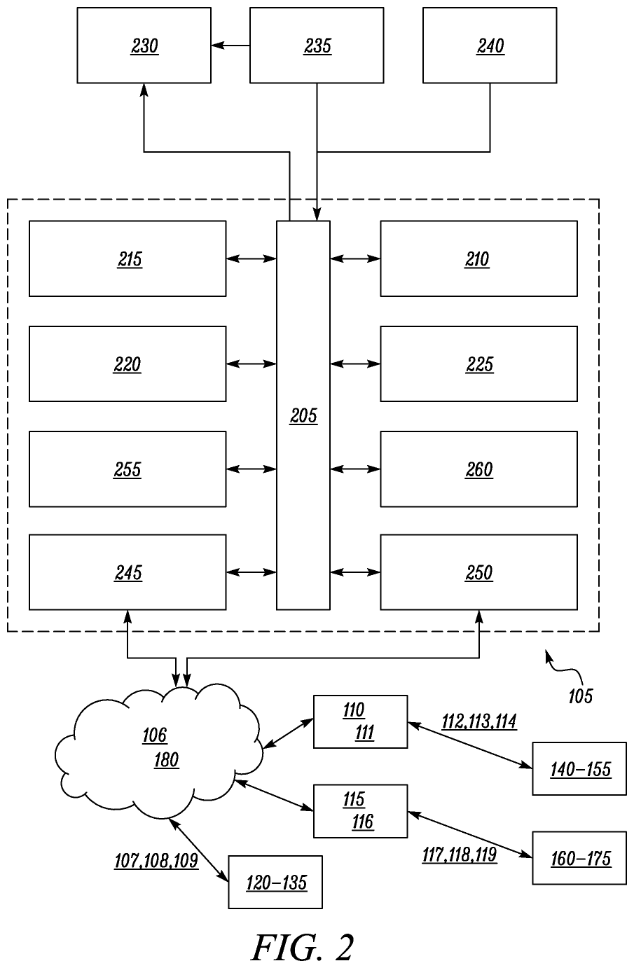

Referring to FIG. 2, a schematic block diagram of different components in the first network device 105 of FIG. 1 associated with the first entity 101 is disclosed. In an embodiment, the first network device 105 includes a bus 205 or other communication mechanism for communicating information, and a processor 210 coupled with the bus 205 for processing information. The first network device 105 also includes a memory 215, such as a random-access memory (RAM) or other dynamic storage device, coupled to the bus 205 for storing information and instructions to be executed by the processor 210. The memory 215 can be used for storing temporary variables or other intermediate information during execution of instructions to be executed by the processor 210. The first network device 105 further includes a read only memory (ROM) 220 or other static storage device coupled to bus 205 for storing static information and instructions for processor 210.

A storage unit 225, such as a magnetic disk or optical disk, is provided and coupled to the bus 205. The storage unit 225 may store one or more custom applications associated with an entity, such as, the first entity 101. The storage unit 225 may also store one or more custom applications associated with other entities such as, the entities 102, 103. The custom applications may comprise an executable and/or one or more files associated with the executable respectively. The storage unit 225 may also store one or more media inputs.

The first network device 105 can be coupled via the bus 205 to a display 230, such as, but not limited to, a cathode ray tube (CRT), and liquid crystal display (LCD) for displaying information to the user. An input device 235, including alphanumeric and other keys, is coupled to bus 205 for communicating information and command selections to the processor 210. Another type of user input device is a cursor control 240, such as a mouse, a trackball, or cursor direction keys for communicating direction information and command selections to the processor 210 and for controlling cursor movement on the display 230. The input device 235 can also be included in the display 230, for example a touch screen and may also include compatible devices with the display 230 such as a stylus. Further, the input device 235 can also include audio-visual devices such as a microphone or a camera and gesture control devices such as wearables. In addition, the input device 235 may correspond to a Universal Serial Bus (USB) device that may provide data including, but not limited to, the custom applications, the files associated with the custom applications, and the media inputs to the first network device 105. The first network device 105 may be configured to access the data stored in USB device and store the data in the storage unit 225.

Various embodiments are related to the use of first network device 105 for implementing the techniques described herein. In one embodiment, the techniques are performed by the first network device 105 in response to the processor 210 executing instructions included in the memory 215. Such instructions can be read into the memory 215 from another machine-readable medium, such as the storage unit 225. Execution of the instructions included in the memory 215 causes the processor 210 to perform the process steps described herein.

The term “machine-readable medium” as used herein refers to any medium that participates in providing data that causes a machine to operate in a specific fashion. In an embodiment implemented using the first network device 105. various machine-readable medium is involved, for example, in providing instructions to the processor 210 for execution. The machine-readable medium can be a storage media. Storage media includes both non-volatile media and volatile media. Non-volatile media includes, for example, optical or magnetic disks, such as storage unit 225. Volatile media includes dynamic memory, such as the memory 215. All such media must be tangible to enable the instructions carried by the media to be detected by a physical mechanism that reads the instructions into a machine.

Common forms of machine-readable medium include, for example, a floppy disk, a flexible disk, hard disk, magnetic tape, or any other magnetic medium, a CD-ROM, any other optical medium, punch cards, paper-tape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fiber optics, including the wires that comprise the bus 205. Transmission media can also take the form of acoustic or light waves, such as those generated during radio-wave and infra-red data communications. Examples of machine-readable medium may include, but are not limited to, a carrier wave as described hereinafter or any other medium from which the first network device 105 can read, for example online software, download links, installation links, and online links. The bus 205 carries the data to the memory 215, from which the processor 210 retrieves and executes the instructions. The instructions received by the memory 215 can optionally be stored on storage unit 225 either before or after execution by the processor 210. All such media must be tangible to enable the instructions carried by the media to be detected by a physical mechanism that reads the instructions into a machine.

The first network device 105 also includes a wired or wireless router 245 communicatively coupled to the memory 215 and the processor 210 via the bus 205. The router 245 may be configured to provide the first LAN 106. The first LAN 106 may be a wired or wireless LAN. The router 245 provides a two-way data communication coupling to the network 180. For example, the router 245 can provide a data communication connection to a corresponding type of and/or a compatible wired and/or wireless router associated with other network devices such as, the second network device 110 and/or the third network device 115. In wired and/or wireless implementations, the router 245 may send and receives electrical, electromagnetic or optical signals that carry digital data streams representing various types of information.

The first network device 105 also includes an access point 250 that is communicatively coupled to the router 245. In an embodiment, the router 245 may be configured to be the access point 250 and perform functions associated with the access point 250. In an embodiment, the access point 250 may be a separate component that may be positioned within a communication range of the first network device 150. In an embodiment, the access point 250 may extend the communication range of the first network device 105. In an embodiment, multiple access points similar to the access point 250 may be communicatively coupled to the router 245. In such embodiments, the multiple access points may also extend the communication range of the first network device 105. The access point 250 may be configured to provide one or more virtual access points such as, but not limited to, the first virtual access points 107-109 for connecting user devices 120-135 to the first LAN 106. In some embodiments, the router 245 may perform the functions of the access point 250 and the first network device 105 may not comprise a separate access point 250.

The first network device 105 also includes a local domain name system (DNS) server 255 coupled to the router for storing one or more service set identifiers (SSIDs) associated with the first network device 105 associated with the first entity 101 and other remote network devices such as, the network devices 110, 115 associated with remote entities such as, the entities 102, 103. The local DNS server 255 may also store the Media Access Control (MAC) addresses of the first user devices 120-135 connected to the first LAN 106. In some embodiments, the local DNS server 255 may also store the MAC addresses of the second user devices 120-135 connected to the second LAN 111 and/or the MAC addresses of the third user devices 160-175 connected to the third LAN 116. In some embodiments, the first network device 105 also includes a public domain name system (DNS) server 260 coupled to the router 245 for storing one or more Internet Protocol (IP) addresses associated with other public DNS servers that are inter-connected with the public DNS server 260 of the first network device 105 via the Internet. In some embodiments, the local DNS server 255 may also store the custom applications associated with the first entity 101 and the remote entities 102, 103. In an embodiment, the custom applications stored may associated with the SSIDs of the network devices 105, 110, 115 respectively.

The first network device 105 is in communication with other network devices, for example, 110, 115 via the network 180. The network 180 may be a wired Ethernet cable network or a wireless (Wi-Fi) network. The network devices 105, 110, 115 may also be within the communication range of each other. The first network device 105 is in communication with the first user devices 120-135 via the first LAN 106. The network devices 110, 115 may be in communication with the second user devices 140-155 and the third user devices 160-175 via the LANs 111, 116 respectively. The first network device 105 may also be in communication with the second user devices 140-155 and the third user devices 160-175 via the network devices 110, 115 respectively. In an embodiment, the LANs 106, 111, 116 may correspond to wireless LANs provided by the network devices 105, 110, 115 respectively.

In some embodiments, the router 245, the access point 250, the local DNS server 255 and the public DNS server 260 may be separate components that may collectively be referred to as the first network device 105. In such embodiments, the processor 210, the memory 215, the ROM 220, the storage unit 225, the display 230, the input device 235, and/or the cursor control 240 may be incorporated in the router 245, the access point 250, the local DNS server 255 and/or the public DNS server 260.

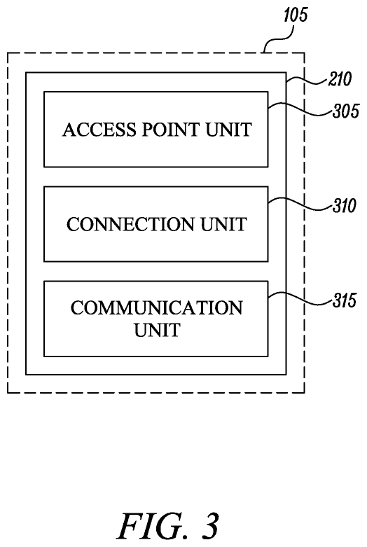

In some embodiments, the processor 210 may be capable of executing the one or more predefined computer instructions in order to perform one or more functions of the first network device 105. The processor 210 may also comprise one or more units 305-315 as shown in FIG. 3 to perform the functions. The units 305-315 in the processor 210 may correspond to a combination of hardware circuitry and software components configured to the perform the functions.

Referring to FIGS. 2-3, the processor 210 may include an access point unit 305, a connection unit 310, and a communication unit 320 to perform the functions of the first network device 105.

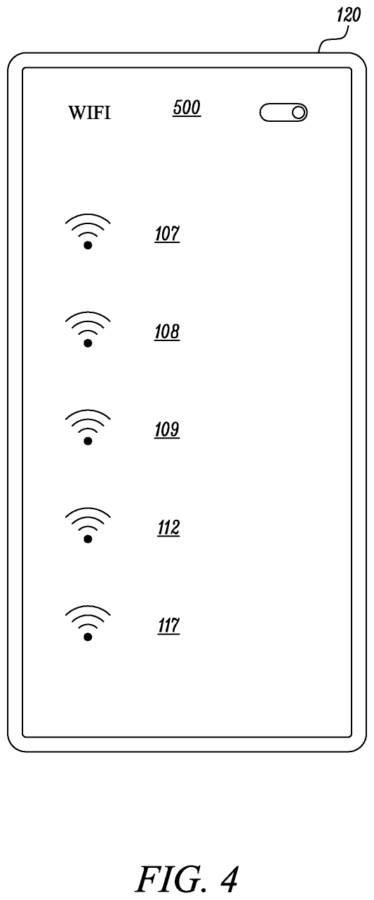

The access point unit 305 may be configured to provide the first virtual access points 107-109 associated with the first entity 101 via the access point 250. In an embodiment, the first virtual access points 107-109 may correspond to subsets of the first entity 101 respectively including, but not limited to, different sub-entities, store locations, and/or store sub-section names associated with the first entity 101. In an embodiment, the first virtual access points 107-109 may be associated with a sub-entity of the first entity 101. In an exemplary example, the first entity 101 may be a clothing brand such as Adidas® and the first virtual access points 107-109 provided by the first network device may correspond to different store sub-sections such as Men's Section, Women's section, and/or Children's section in a physical store of the first entity 101. In an embodiment, the access point unit 305 may also provide the virtual access points 112-114, 117-119 associated with the remote entities 102, 103 respectively via the access point 250. In such embodiments, the virtual access points 112-114, 117-119 may be associated with the SSIDs of the remote network devices 110, 115. The virtual access points 107-109, 112-114, 117-119 may be detectable by the first user devices 120-125. In an exemplary example, the first user devices 120-125 may detect and display the virtual access points 107-109, 112-114, and/or 117-119 on the first user devices 120-125. Referring to FIG. 4, an exemplary illustration of the first user device 120 of FIG. 1 detecting virtual access points 107-109, 112-114, 117-119 provided by the first network device of FIGS. 1-3 is disclosed. A user of the first user device, for example, 120 may select a virtual access point, for example, the first virtual access point 107 associated with the first entity 101, the second virtual access point 112 associated with the second entity 102, or the third virtual access point 117 associated with the third entity 103 to request a connection. The user may select the virtual access point via one or more input means such as, but not limited to, a display 500 that is touchscreen enabled and provided on the first user device 120 to request the connection. The first user devices 120-125 may be able to detect and display the virtual access points 107-109, 112-114, and/or 117-119 when the first user devices 120-125 are within the communication range of the first network device 105.

Referring again to FIGS. 2-3, the connection unit 310 may be configured to receive the request for connection via the virtual access point, for example, the first virtual access point 107 from the first user devices 120-135. The connection unit 310 may then connect the first user devices 120-125 to the first LAN 106 via the first virtual access point 107. The connection unit 310 may connect the first user devices 120-125 to the first LAN 106 for any of the virtual access points 107-109. 112-114, and/or 117-119 selected by the user to request the connection.

The communication unit 315 may be configured to provide one or more custom applications on the first user devices 120-125 connected to the first LAN 106. Examples of the custom applications include, but are not limited to, e-commerce applications, chat or customer support applications, social media applications, and advertising applications. The communication unit 315 may facilitate the geographically localized communication with the first entity 101 via the custom applications. In such embodiments, the custom applications may be associated with the first entity 101 or one or more sub-entities of the first entity 101. In some embodiments, the communication unit 315 may also be configured to provide one or more custom applications associated with the other remote entities such as, the entities 102, 103 in order to receive a request for the geographically localized communication with the other remote entities such as, the entities 102, 103.

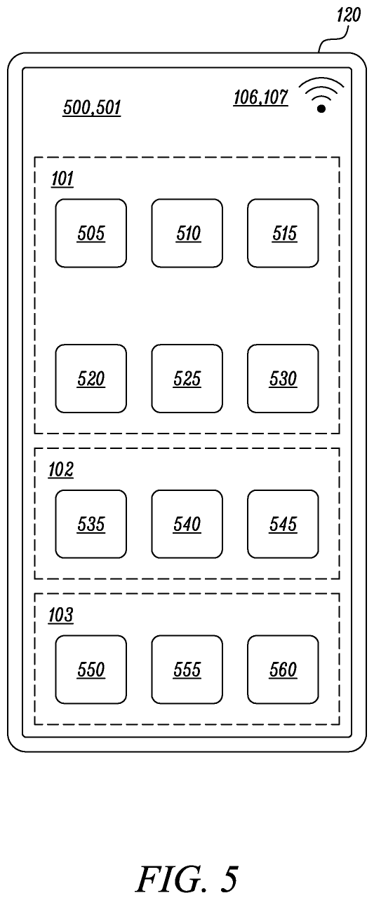

Referring to FIG. 5, an exemplary illustration of custom applications associated with the entities 101, 102, 103, provided on the first user device 120 of FIG. 4 by the communication unit 315 of the first network device 105 of FIGS. 1-3 is disclosed. The communication unit 315 may provide custom applications 505-530 on the first user device 120 for facilitating the geographically localized communication with the first entity 101. Similarly, the communication unit 315 may provide the custom applications 535-545 associated with the second entity 102 and the custom applications 550-560 associated with the third entity 103 on the first user device 120. In an embodiment, the communication unit 315 may provide the custom applications on the display 500 of the first user device 120. In an embodiment, the communication unit 315 may provide the custom applications as an executable application on the first user device 120. In some embodiments, the communication unit 315 may directly execute and provide a user interface 501 of a custom application on the first user device 120. In some embodiments, the user interface 501 of the custom application provided on the first user device 105 may comprise links and/or connections to other custom applications associated with the entities 101, 102, 103. For example, the communication unit 315 may provide the user interface 501 on the display 500 comprising the custom applications 505-530, 535-545, 550-560.

Referring again to FIGS. 2-3, in an embodiment, the communication unit 315 may automatically provide the custom application based on the virtual access point selected by the user to request the connection and/or the SSIDs associated with the network devices 105, 110, 115. In such embodiments, the custom application may be associated with the selected virtual access point and/or the SSID of the network device, for example, 105. For example, when a user selects the second virtual access point 112 on the first user device 120 to request the connection, the communication unit 315 may first connect the first user device 120 to the first LAN 106 and then automatically provide the second custom application 535 (see FIG. 5) associated with the second entity 102 on the first user device 120. In such embodiments, based on the SSID associated with the virtual access point, the communication unit 315 may request the remote network device associated with the virtual access point to provide the custom application. For example, based on the SSID of the second network device 110 stored in the local DNS server 255 of the first network device 105, the communication unit 315 may be able to request the second network device 110 associated with the virtual access point 112 to provide the second custom application. The communication unit 315 may then receive the custom application from the remote second network device, for example, 110 via the router 245. The communication unit 315 may store the custom application received from the remote network device in the local DNS server 255 and/or the storage unit 225. The communication unit 315 may then provide the custom application received from the remote network device, for example, 120 on the first user devices 120-135 connected to the first LAN 106. The communication unit 315 may thereby facilitate the geographically localized communication between the first user devices 120-135 and the remote entities 102, 103. In an embodiment, the custom application(s) provided on the first user device 120 by the communication unit 315 may enable the user of the first user device 120 to access one or more products/services offered by the entities 101, 102, and/or 103.

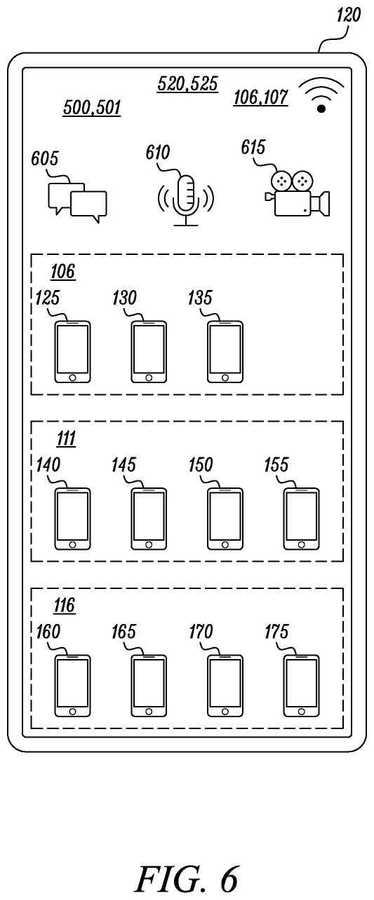

Referring to FIG. 6, an exemplary illustration of the first custom application (520/525) of FIG. 5 associated with a first entity 101 provided on the first user device 120 of FIG. 4 by the first network device 105 of FIGS. 1-3 is disclosed. The custom application(s), for example, 520 or 525 (see FIG. 5) provided on the first user device, for example, 120 may be configured to facilitate the geographically localized communication between the first user device 120 and the other first user devices 125-135. Similarly, the custom application(s), for example, 520 or 525, provided on the first user device, for example, 120 may be configured to facilitate the geographically localized inter-communication between the first user device 120 and second user devices 140-155 and/or the third user devices 160-175. In such embodiments, exemplarily, the custom application may be a chat application 520 or a social media application 525. Further, in such embodiments, the communication unit 315 (see FIG. 3) may be configured to receive at least one media input such as, but not limited to, a text, an image, a video, and/or a livestream broadcast input from the first user device, for example, 120 via the custom application, for example, 520. For example, the custom application 520 may provide input options 605, 610, 615 on the user interface 501 that may correspond to text, the audio, and the video inputs respectively on the first user device 120 and receive the media input via the input options 605, 610, 615.

Referring again to FIGS. 2-3, in an embodiment, the communication unit 315 may store the media input received from the first user device 120 in the storage unit 225. The communication unit 315 may then provide the media input received from the first user device 120 to other first user devices, for example, 125-135 connected to the first LAN 106. The communication unit 315 may also provide the media input received from the first user device 120 to the second user devices 140-155 connected to the second LAN 111 and/or the third user devices 160-175 connected to third LAN 116. In such embodiments, the communication unit 315 may first provide the media input to other network devices, for example, 110, 115 via the router 245 and the network 180. The other network devices 110, 115 may in turn provide the media input received from first user device 120 and the communication unit 215 to the second user devices 140-155 connected to the second LAN 111 and/or the third user devices 160-175 connected to third LAN 116 respectively. For example, the communication unit 315 may receive a video from the first user device 120 and provide the video to the first user device 135 via the first LAN 106, and to the network devices 110, 115 respectively. The network devices 110, 115 may in turn provide the video to the second user device 140 connected to the second LAN 111 and the third user device 160 connected to the third LAN 116 via the second custom application, for example, 535 and the third custom application, for example, 550 respectively. In such embodiments, the first, second, and third custom applications 520, 535, 550 (see FIG. 5) provided on the first, second, and third user devices 120, 140, 160 may be similar. In an embodiment, the user of the first user device, for example, 120 may select the user devices to which the media input has to be provided. For example, the user of the first user device 120 may choose to provide the media input only to the second user device 140 and/or the third user device 160. In such embodiments, communication unit 315 may first detect and display the other first user devices 125-135 connected to the first LAN 106 via respective MAC addresses of the first user devices 125-135 identified by the communication unit 315. In an embodiment, the communication unit 315 may also request the network devices 110, 115 based on the SSIDs in the local DNS server to provide information related to the user devices connected to the respective LANs via the network 180. For example, the communication unit 315 may request the second network device 110 to provide information related to the second user devices 140-155 connected to the second LAN 111 and/or the third network device 115 to provide information related to the third user devices 160-175 connected to third LAN 116. The communication unit 315 may then display the other first user devices 125-135 connected to the first LAN 106. The communication unit 315 may also retrieve and display the second user devices 140-155 connected to the second LAN 111 and/or the third user devices 160-175 connected to the third LAN 116 from the second network device 110 and the third network device 115 respectively via the network 180. The communication unit 315 may display the user devices connected to the respective LANs 106, 111, 116 via the user interface 501 of the first custom application 520/525 (see FIG. 5) provided on the first user device, for example, 120. In an embodiment, the communication unit 315 may store the MAC addresses of the second user devices 140-155 and/or the third user devices 160-175 in the local DNS server 255 and/or the storage unit 225. The user of the first user device, for example, 120 may then select the user devices displayed on the user interface 501 by the communication unit 700 to provide the media input. In another embodiment, the communication unit 315 may provide the media input received from the first user device 105 to other first user devices 125-135 connected to the first LAN 106, the second user devices 140-155 connected to the second LAN 111 and/or the third user devices 160-175 connected to third LAN 116 simultaneously based on the stored SSIDs of the other network devices 102, 103 and the MAC addresses.

In some embodiments, the custom application(s) provided on the first user devices 120-135 may be configured to retrieve data from the other public DNS servers via the Internet based on the IP addresses stored in the public DNS server 260. Examples of the data include, but are not limited to, information and/or applications. Examples of the information include, but are not limited to, global positioning system (GPS) related information, weather related information, and web information. In such embodiments, the communication unit 315 may receive a request for information from the custom application, for example, the first custom application 505 (see FIG. 5), provided on the first user device, for example, 120. The communication unit 315 may query the storage unit 225, the local DNS server 255, and/or the other network devices 102, 103 and then determine that the information is unavailable. The communication unit 315 may also determine that the information is available on the Internet by passing the query to the public DNS server 260. The public DNS server 260 may then query other public DNS servers via the Internet based on the stored IP addresses and receive the information. The communication unit 315 may then store the received information in the storage unit 225 and/or the public DNS server 260. The communication 315 unit may then provide information to the first user device, for example, 120 via the custom application, for example, the first custom application 505.

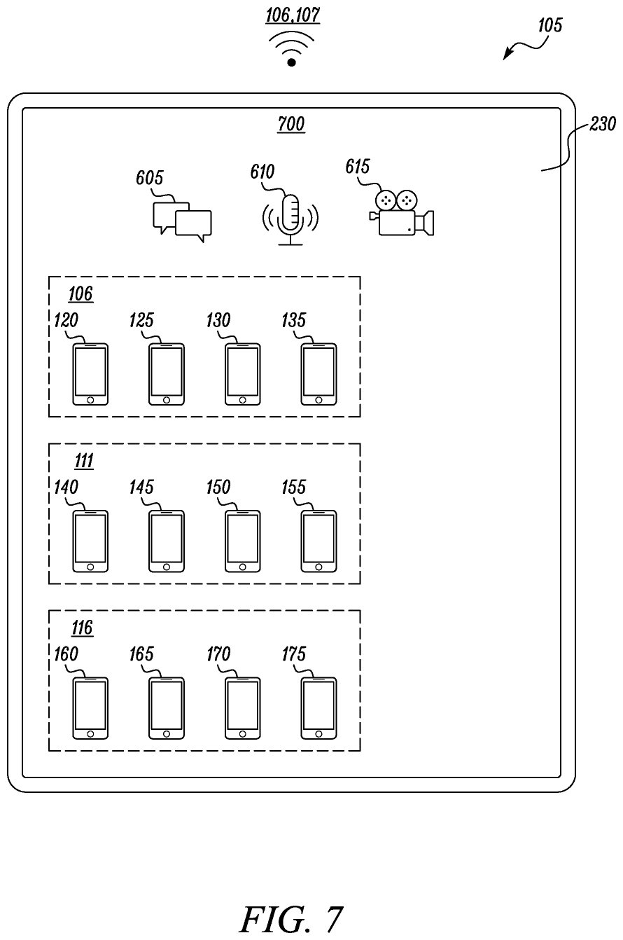

In some embodiments, the communication unit 315 may be configured to receive at least one media input such as, but not limited to, a text, an image, a video, and/or a livestream broadcast directly via the input means 235 such as a keyboard input, a touchscreen display, and/or the cursor control 240. Referring to FIG. 7, an exemplary illustration of a user interface 700 provided on the first network device 105 of FIGS. 1-3 is disclosed. In an embodiment, the communication unit 315 (see FIG. 3) may provide a user interface 700 on the display 230 of the first network device 105 to receive the media input. For example, the communication unit 315 may provide the input options 605, 610, 615 on the user interface 700 that may correspond to the text, the audio, and the video inputs respectively and receive the media input via the input options 605, 610, 615. The user interface 700 may be associated with a custom application provided in the first network device 105.

Referring again to FIGS. 2-3, in an embodiment, the communication unit 315 may store the media input received in the storage unit 225. The communication unit 315 may then provide the media input received to the first user devices 120-135 connected to the first LAN 106, the second user devices 140-155 connected to the second LAN 111 and/or the third user devices 160-175 connected to third LAN 116 based on the stored SSIDs and/or the MAC addresses. In such embodiments, the communication unit 315 may first provide the media input to other network devices, for example, 110, 115 via the router 245 and the network 180. The other network devices 110, 115 may in turn provide the media input received from first network device 105 to the second user devices 140-155 connected to the second LAN 111 and/or the third user devices 160-175 connected to third LAN 116 respectively. For example, the communication unit 315 may receive a video announcement from the first network device 105 and provide the video announcement to the first user device 135 via the first LAN 106 and the MAC address of the first user device 135 via the first custom application 520 (see FIG. 5). The communication unit 315 may also provide the video announcement to the network devices 110, 115 and to the second user devices 140-155 and the third network devices 160-175 based on the SSIDs of the network devices 110, 115 respectively and the MAC addresses of the user devices 140-175. The network devices 110, 115 may in turn provide the video announcement to the second user device, for example, 140 connected to the second LAN 111 and the third user device, for example, 160 connected to the third LAN 116 via the second custom application, for example, 535 (see FIG. 5) and the third custom application, for example, 550 (see FIG. 5) respectively. In such embodiments, the first, second, and third custom applications 520, 535, 550 provided on the first, second, and third user devices 120, 140, 160 may be similar. In an embodiment, the first entity 101 associated with the first network device 125 may also select the user devices to which the media input has to be provided via the user interface 700. For example, the first entity 101 may choose to provide the media input only to the first user device 120, the second user device 140 and/or the third user device 160. In such embodiments, communication unit 315 may first detect and display the first user devices 120-135 connected to the first LAN 106 via respective MAC addresses of the first user devices 120-135 identified by the communication unit 315. In an embodiment, the communication unit 315 may also request the network devices 110, 115 based on the SSIDs in the local DNS server to provide information related to user devices connected to respective LANs. For example, the communication unit 315 may also request the second network device 110 to provide information related to the second user devices 140-155 connected to the second LAN 111 and/or the third network device 115 to provide information related to the third user devices 160-175 connected to third LAN 116. The communication unit 315 may then retrieve and display the second user devices 140-155 connected to the second LAN 111 and/or the third user devices 160-175 connected to the third LAN 116 on the user interface 700 (see FIG. 7) of the first network device 105 from the second network device 110 and the third network device 115 respectively via the network 180. In an embodiment, the communication unit 315 may store the MAC addresses of the second user devices 140-155 and the third user devices 160-175 in the local DNS server 255 and/or the storage unit 225. The first entity 101 associated with the first network device 125 may then select the user devices displayed on the user interface 700 by the communication unit 315 to provide the media input received. In another embodiment, the communication unit 315 may provide the media input received via the user interface 700 of the first network device 105 to the first user devices 120-135 connected to the first LAN 106, the second user devices 140-155 connected to the second LAN 111 and/or the third user devices 160-175 connected to third LAN 116 simultaneously.

### INDUSTRIAL APPLICABILITY

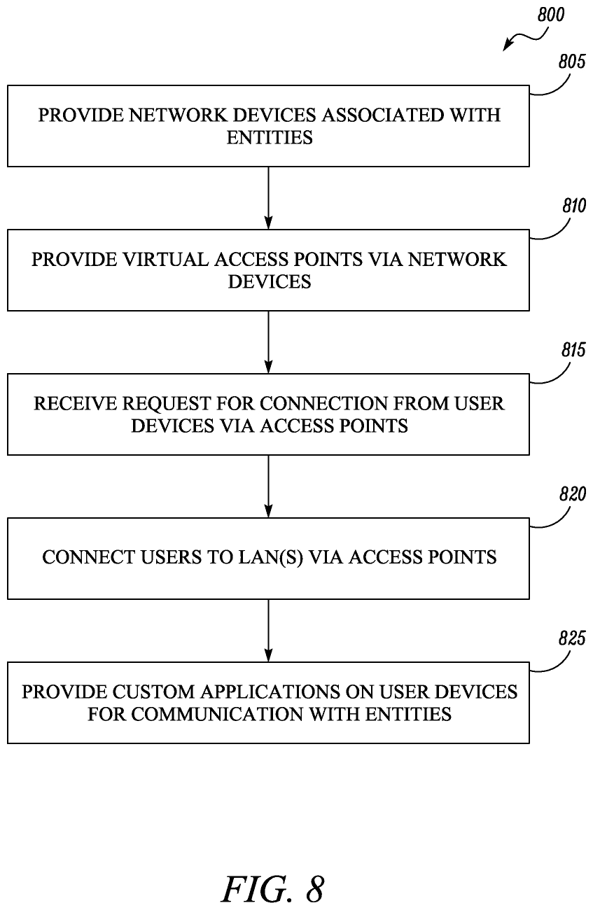

Referring to FIG. 8, a flowchart of a method 800 for facilitating a geographically localized communication with the entities 101, 102, 103 via the multi-network system 100 of FIG. 1 is disclosed. The method 800 comprises a step 805 of providing the network devices 105, 110 associated with the entities 101, 102, 103. The network devices 105, 110, and 115 are configured to communicate with each other via the network 180 and also provide the LAN 106, 111, and 116 respectively. The method 800 also comprises a step 810 of providing the virtual access points 107-109, 112-114, and 117-119 via the network devices 105, 110, and 115 respectively. The virtual access points 107-109, 112-114, and 117-119 are detectable by the user devices 120-135, 140-155, and 160-175 respectively. Further, the method 800 comprises a step 815 of receiving a request for connection via at least one virtual access point, for example, virtual access point 107, of the virtual access points 107-109, 112-114, and 117-119 from the user devices, for example, 120-135. The virtual access point 107 is associated with the network device 105.

Furthermore, the method 800 comprises a step 820 of connecting the user devices 120-135 to the LAN 106 provided by the network device 105 via the virtual access point 107. In addition, the method 800 comprises a step 825 of providing at least one custom application, for example, custom applications 505-515 (see FIG. 5), on the user devices 120-135 connected to the LAN 106 for the geographically localized communication with the entities 101, 102, 103.

It may be appreciated that the network devices 105, 110, 115 and the method 800 of the present disclosure facilitate geographically localized communication between user devices 120-135, 140-155, 160-175 and the entities 101, 102, 103 without requiring connection to the Internet. The network devices 105, 110, 115 and the method 800 of the present disclosure may also facilitate geographically localized communication of the user devices 120-135, 140-155, 160-175 with each other via respective LAN connections with the network devices 105, 110, 115 and the custom applications provided on the user devices 120-135, 140-155, 160-175 respectively. Further, the network devices 105, 110, 115 and the method 800 of the present disclosure also enable the user devices 120-135, 140-155, 160-175 to obtain information related to the entities 101, 102, 103 without use of internet data bandwidth. In some instances, the network devices 105, 110, 115 and the method 800 of the present disclosure may also enable the user devices 120-135, 140-155, 160-175 to obtain information faster in comparison to retrieving it from the Internet, since the retrieval of the information from the Internet often depends on internet connectivity and/or the internet speed provided by internet service providers on the user devices 120-135, 140-155, 160-175. Furthermore, in locations with poor internet connectivity, the network devices 105, 110, 115 and the method 800 of the present disclosure enable the users within the communication range of the network devices 105, 110, 115 to communicate with each other via respective user devices for instances when, for example, a user is displaced or lost. Similarly, the network devices 105, 110, 115 and the method 800 of the present disclosure enables the entities 101, 102, 103 to broadcast a media input such as a message and/or an offering directly to the user devices 120-135, 140-155, 160-175 via respective LANs provided by the network devices 105, 110, 115. Therefore, the entities 101, 102, 103 do not have to rely on the Internet or internet connectivity to do so. Furthermore, the network devices 105, 110, 115 and the method 800 of the present disclosure enables the entities 101, 102, 103 to communicate directly with the users without requiring significant power in tracking the users via location tracking methods and without using internet data bandwidth. As an added advantage, the network devices 105, 110, 115 and the method 800 of the present disclosure enable discoverability of the entities 101, 102, 103 and/or the products/service offerings of the entities 101, 102, 103 when the user devices 120-135, 140-155, 160-175 are within the communication range of the network devices 105, 110, 115 associated with the entities 101, 102, 103. Further, by facilitating exchange of the media input between the users in the communication range, the network devices 105, 110, 115 and the method 800 of the present disclosure also enable discoverability of the users, user content, and/or user skills/talents/abilities via the user devices 120-135, 140-155, 160-175 that are within the communication range of the network devices 105, 110, 115.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

We claim:

1. A network device associated with an entity for facilitating a geographically localized communication with the entity, comprising:
a memory to store one or more computer instructions;
a router for providing a local area network (LAN);
an access point communicatively coupled to the router for providing one or more virtual access points associated with the entity;
a storage unit comprising one or more custom applications, wherein the one or more custom applications are associated with the entity; and
a processor configured to execute the one or more computer instructions in order perform one or more functions, the one or more functions comprising:
providing the one or more virtual access points via the access point, wherein the one or more virtual access points are detectable by one or more user devices;
receiving a request for connection via at least one virtual access point of the one or more virtual access points from the one or more user devices;
connecting the one or more user devices to the LAN via the at least one virtual access point; and
providing at least one custom application of the one or more custom applications to the one or more user devices connected to the LAN for the geographically localized communication with the entity.

2. The network device of claim 1, wherein each virtual access point of the one or more virtual access points is associated with a subset of the entity.

3. The network device of claim 2, wherein each custom application of the one or more custom applications is associated with a corresponding virtual access point of the one or more virtual access points and the at least one custom application provided is based on the at least one virtual access point that connects the one or more user devices to the LAN.

4. The network device of claim 3, wherein at least one custom application provided on the one or more user devices is associated with the subset of the entity.

5. The network device of claim 1, wherein the at least one custom application provided on the one or more user devices enables the one or more user devices connected to the LAN to communicate with each other.

6. The network device of claim 1, wherein the processor receives a request for another custom application of the one or more custom applications via the at least one custom application provided on the one or more user devices, and the one or more functions comprise providing the requested custom application to the one or more user devices.

7. The network device of claim 1, wherein the one or more functions comprise:
receiving at least one media input from a user device of the one or more user devices; and
providing the at least one media input received from the user device to other user devices of the one or more user devices connected to the LAN.

8. The network device of claim 1, comprising:
a display for providing a user interface or the one or more custom applications; and
an input means to receive at least one media input, wherein the one or more functions comprise providing the at least one media input received via the input means to the one or more user devices connected to the LAN.

9. A network device associated with an entity for facilitating a geographically localized communication with one or more remote entities, comprising:
a memory to store one or more computer instructions;
a router for providing a local area network (LAN);
an access point coupled to the router for providing one or more virtual access points associated the one or more remote entities;
a local domain name system (DNS) server coupled to the router for storing one or more service set identifiers (SSIDs) associated with one or more remote network devices, wherein the one or more remote network devices are associated with one or more remote entities respectively and are in communication with and within a communication range of the network device;
a storage unit for storing one or more custom applications associated with the one or more remote entities respectively, wherein the one or more custom applications are associated with the one or more SSIDs of the one or more remote network devices; and
a processor configured to execute the one or more computer instructions in order perform one or more functions, the one or more functions comprising:
providing the one or more virtual access points associated with the one or more remote entities via the access point; wherein the one or more virtual access points are detectable by one or more user devices and are associated with the one or more SSIDs of the one or more remote network devices;
receiving a request for connection via at least one virtual access point of the one or more virtual access points from the one or more user devices;
connecting the one or more user devices to the LAN via the virtual access point;
requesting the one or more remote network devices associated with the at least one virtual access point to provide at least one custom application of the one or more custom applications based on the one or more SSIDs;
receiving the at least one custom application from the one or more remote network devices via the router; and
providing the at least one custom application on the one or more user devices connected to the LAN for the geographically localized communication with the one or more remote entities.

10. A network device for facilitating a geographically localized communication with one or more entities, comprising:
a memory to store one or more predefined computer instructions;
a router for providing a local area network (LAN);
an access point coupled to the router for providing one or more virtual access points;
a processor configured to execute the one or more predefined computer instructions in order perform one or more functions, the one or more functions comprising:
providing the one or more virtual access points via the access point; wherein the one or more virtual access points are detectable by one or more user devices;
receiving a request for connection via at least one virtual access point of the one or more virtual access points from the one or more user devices;
connecting the one or more user devices to the LAN via the virtual access point; and
providing a custom application on the one or more user devices connected to the LAN, wherein the custom application provides access to the one or more entities and facilitates the geographically localized communication with the one or more entities.

11. The network device of claim 10, comprising:
a local domain name system (DNS) server coupled to the router for storing one or more service set identifiers (SSIDs) associated with one or more remote network devices, wherein the one or more remote network devices are associated with one or more entities respectively and are in communication with and within a communication range of the network device; and
a storage unit for storing one or more custom applications associated with the one or more entities respectively, wherein the one or more custom applications are associated with the one or more SSIDs of the one or more remote network devices.

12. The network device of claim 11, wherein the one or more functions comprise:
receiving a request for the geographically localized communication with a first entity of the one or more entities from the one or more user devices via the custom application;
requesting the one or more remote network devices associated with the first entity to provide at least one custom application of the one or more custom applications associated with the first entity based on the one or more SSIDs;
receiving the at least one custom application from the one or more remote network devices associated with the first entity via the router; and
providing the at least one custom application associated with the first entity on the one or more user devices connected to the LAN for the geographically localized communication with the first entity.

13. The network device of claim 12, comprising:
receiving a request from the one or more user devices for communication with a second entity of the one or more entities via the at least one custom application associated with the first entity;
requesting the one or more remote network devices to provide at least one custom application of the one or more custom applications associated with the second entity based on the one or more SSIDs associated with the second entity;
receiving the at least one custom application associated with the second entity from the one or more remote network devices via the router; and
providing the at least one custom application associated with the second entity on the one or more user devices connected to the LAN.

14. The network device of claim 11, comprising:
a public domain name system (DNS) server coupled to the router for storing one or more Internet Protocol (IP) addresses associated with other public DNS servers that are inter-connected with the public DNS server via the Internet.

15. The network device of claim 14, wherein the custom application provided by the network device and the one or more custom applications associated with the one or more entities respectively is configured to retrieve data from the other public DNS servers via the Internet based on the IP addresses.

16. A multi-network system for geographically localized inter-communication, comprising:
a first network device for providing a first local area network (LAN) and one or more first virtual access points associated with a first entity, wherein the first network device is configured to:
receive a first request for connection via at least one first virtual access point of the one or more first virtual access points associated with the first entity from one or more first user devices,
connect the one or more first user devices to the first local area network (LAN), and
provide a first custom application on the one or more first user devices connected to the first LAN; and
a second network device for providing a second local area network (LAN) and one or more second virtual access points associated with a second entity, wherein the second network device is in communication with and within a communication range of the first network device, wherein the second network device is configured to:
receive a second request for connection via at least one second virtual access point of the one or more second virtual access points associated with the second entity from one or more second user devices,
connect the one or more second user devices to the second local area network (LAN) provided by the second network device, and
provide a second custom application on the one or more second user devices connected to the second LAN;
wherein the first custom application and the second custom application are configured to facilitate the geographically localized inter-communication between the one or more first user devices and the one or more second user devices.

17. The multi-network system of claim 16, wherein the first custom application is configured to:
display the one or more second user devices connected to second LAN on the one or more first user devices,
receive a selection of a second user device of the one or more second user devices from a first user device of the one or more first user devices; and
facilitate the geographically localized inter-communication between the first user device connected to the first LAN and the selected second user device connected to the second LAN.

18. The multi-network system of claim 16, wherein the second application is configured to:
display the one or more first user devices connected to first LAN on the one or more second user devices;
receive a selection of a first user device of the one or more first user devices from a second user device of the one or more second user devices; and
facilitate the geographically localized inter-communication between the second user device connected to the second LAN and the selected first user device connected to the first LAN.

19. The multi-network system of claim 16, wherein the first custom application is configured to:
receive at least one media input from a first user device of the one or more first user devices, and
provide the at least one media input received from the first user device to the first network device; and
the first network device is configured to:
provide the at least one media input received from the first user device to other first user devices of the one or more first user devices connected to the first LAN, and
provide the at least one media input received from the first user device to the second network device, wherein the second network device is configured to provide the at least one media input received from the first user device and the first network device to the one or more second user devices connected to the second LAN via the second custom application.

20. The multi-network system of claim 16, wherein the first custom application and the second custom application are similar and comprise a chat application or a social media application.

21. The multi-network system of claim 16, wherein first network device is configured to store one or more service set identifiers (SSIDs) associated with the second network device, one or more Media Access Control (MAC) addresses associated with the one or more first user devices and one or more MAC addresses associated with the one or more second user devices.

22. The multi-network system of claim 21, wherein the first network device facilitates the geographically localized communication between the one or more first user devices and the one or more second user devices based on the one or more SSIDs and the one or more MAC addresses.

23. A method for facilitating a geographically localized communication with one or more entities comprising:
providing one or more network devices associated with the one or more entities, wherein the one or more network devices are configured to communicate with and be within a communication range of each other and provide a LAN respectively;
providing one or more virtual access points via the one or more network devices, wherein the one or more virtual access points are detectable by one or more user devices;
receiving a request for connection via at least one virtual access point of the one or more virtual access points from the one or more user devices, wherein the at least one virtual access point is associated with a network device of the one or more network devices;
connecting the one or more user devices to the LAN provided by the network device via the at least one virtual access point; and
providing at least one custom application on the one or more user devices connected to the LAN for the geographically localized communication with the one or more entities.

24. The method of claim 23, wherein the method comprises:
facilitating the geographically localized inter-communication between the one or more user devices connected to the LAN and between the one or more user devices connected to the LAN provided by the network device and the one or more users connected to the LAN provided by other network devices of the one or more network devices, wherein the one or more users are connected to the LAN provided by other network devices via the one or more virtual access points provided by the other network devices.
